(19) United States
(12) Patent Application Publication
(10) Pub. No.: US 2010/0216494 A1
(43) Pub. Date: Aug. 26, 2010

(54) System and Method For Anonymous Mobile Messaging

(76) Inventor: Hubert Abdel-Moiti Moik, Wedemark (DE)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/712,946

(22) Filed: Feb. 25, 2010

Related U.S. Application Data
(60) Provisional application No. 61/155,265, filed on Feb. 25, 2009.

(51) Int. Cl. H04W 4/12

(52) U.S. Cl. 455/466

(57) ABSTRACT

The present system and method provides anonymous mobile messaging between users. According to one embodiment, an anonymous mobile messaging system allows a sender to send a message, such as an SMS, from his mobile phone to a recipient's mobile phone without the sender having to know the mobile phone number of the recipient or without the sender having to reveal his own mobile phone number to the recipient.

The present application claims the benefit of and priority to U.S. Provisional Patent Application No. 61/155,265 filed on Feb. 25, 2009, entitled “System and Method for Anonymous Mobile Messaging,” which is herein incorporated by reference.

### FIELD

The present system and method relate to mobile messaging, and particularly, to anonymous mobile messaging.

### BACKGROUND

Today, mobile phones are used to perform a wide variety of tasks. Besides providing the audio communication functions of a traditional telephone, most mobile phones enable users to exchange information in the form of text via SMS or in the form of multimedia—including pictures and audio and video clips—via MMS. Some mobile phones are even capable of internet access, enabling mobile phone users to access worldwide web resources and to communicate with each other through email, instant messaging, or blogging.

Despite the other available features on mobile phones, Short Message Service, or SMS, remains the most common mode for messaging between mobile phones because of its early adoption and widespread support infrastructure. SMS is a standardized module that provides for the exchange of text messages, usually between mobile phones, but some systems support SMS-to-Web or Web-to-SMS. For instance, a web instant messenger client may allow a user to send an SMS to a mobile phone or to receive an SMS from a mobile phone. Conventionally, a sender who wishes to send an SMS on his mobile phone is identified to the recipient by his mobile phone number. Similarly, a recipient who wishes to receive an SMS on his mobile phone is addressed by his mobile phone number. Thus, using conventional technology, two mobile phone users wishing to communicate with each other via SMS have to know each other's mobile phone number.

In addition to using SMS to communicate between acquaintances, users may want to communicate via SMS with complete strangers or someone they recently met. These occasions may arise when a user is participating in online dating or is selling an item through a website. However, users who give out their mobile phone numbers to strangers may be presenting themselves to real security risks. This is especially true with the accessibility of “reverse look up” services, which enable anyone to look up the name and address of a user associated with a certain mobile phone number.

In view of the foregoing, there exists a need for a system and method for anonymous mobile messaging.

### SUMMARY

According to one embodiment, a system comprises a shortcode that identifies an anonymous mobile messaging system; an I/O module of the anonymous mobile messaging system that receives a message from a sender's service provider and sends the message to a recipient's service provider; and a recipient management module of the anonymous mobile messaging system that identifies an intended recipient of the message based on a recipient's nickname in the message.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles described herein.

FIG. 1A illustrates a high-level block diagram describing prior art operations of mobile messaging;

FIG. 1B illustrates a high-level block diagram describing exemplary operations of mobile messaging with an anonymous mobile messaging (AMM) system, according to one embodiment;

FIG. 2A illustrates a prior art interface for a sender to configure an out-going mobile message;

FIG. 2B illustrates an exemplary interface for a sender to configure an out-going mobile message, according to one embodiment;

FIG. 2C illustrates an exemplary out-going message configured by the sender, according to one embodiment;

FIG. 3A illustrates a prior art interface for a recipient to view a message received from a sender;

FIG. 3B illustrates an exemplary interface for a recipient to view a message received from a sender, according to one embodiment;

FIG. 3C illustrates an exemplary message received by a recipient from a sender, according to one embodiment;

FIG. 4 illustrates a block diagram describing exemplary operations of an anonymous mobile messaging (AMM) system, according to one embodiment;

FIG. 5 illustrates a block diagram describing exemplary operations of the guest user management module, according to one embodiment;

FIG. 6 illustrates a block diagram describing exemplary operations of the keyword management module, according to one embodiment;

FIG. 7 illustrates a block diagram describing exemplary operations of the suffix management module, according to one embodiment;

FIG. 8 illustrates an exemplary block diagram of senders sending messages to recipients in the same or a different country, according to one embodiment; and

FIG. 9 illustrates a block diagram describing exemplary operations and criteria of the country provider management module, according to one embodiment.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not describe every aspect of the teachings disclosed herein and do not limit the scope of the claims.

### DETAILED DESCRIPTION

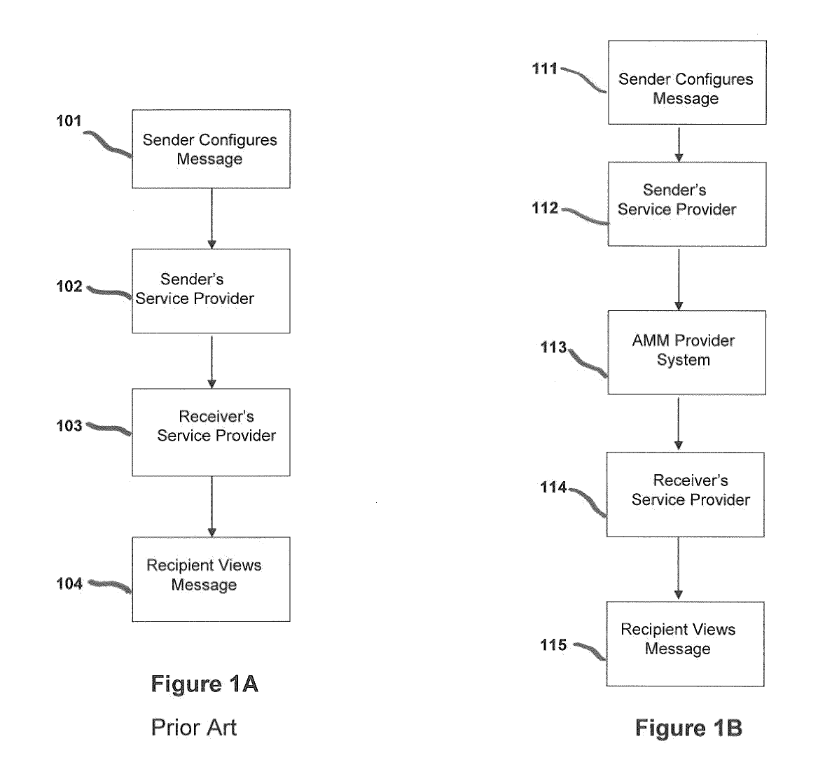

FIG. 1A illustrates a high-level block diagram describing prior art operations of mobile messaging. Initially, the sender, a user who wishes to send a message, configures the message at 101. After the message has been configured, the message is transmitted to the sender's mobile phone service provider (SSP) at 102. The SSP transmits the message to the recipient's mobile service provider (RSP) at 103. The RSP transmits the message to the recipient at 104, where the recipient can view the message along with the identity of the sender.

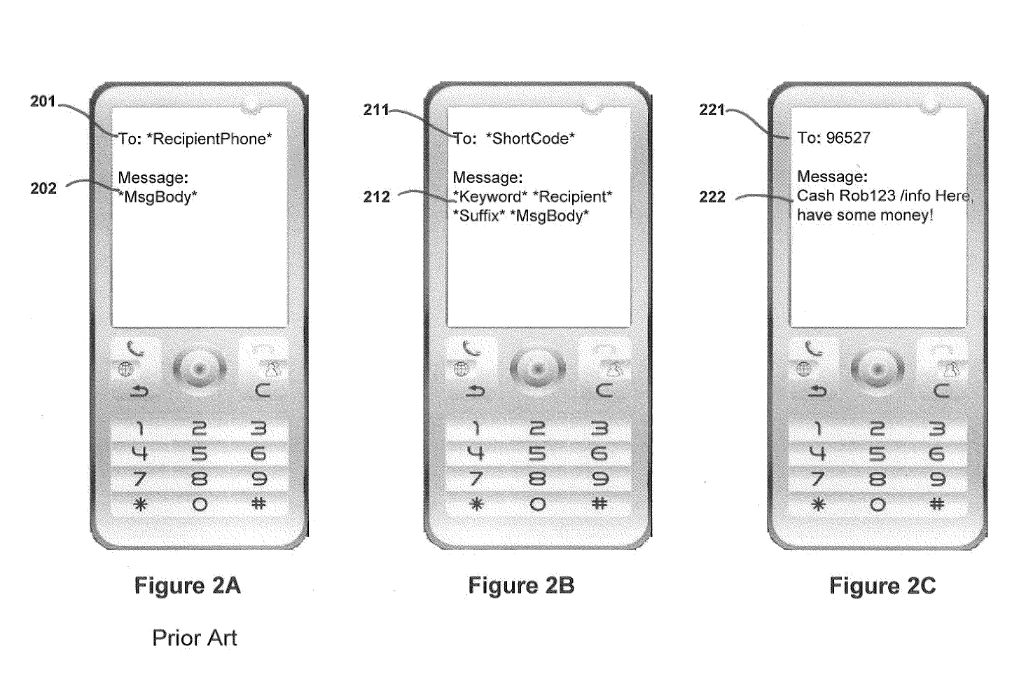

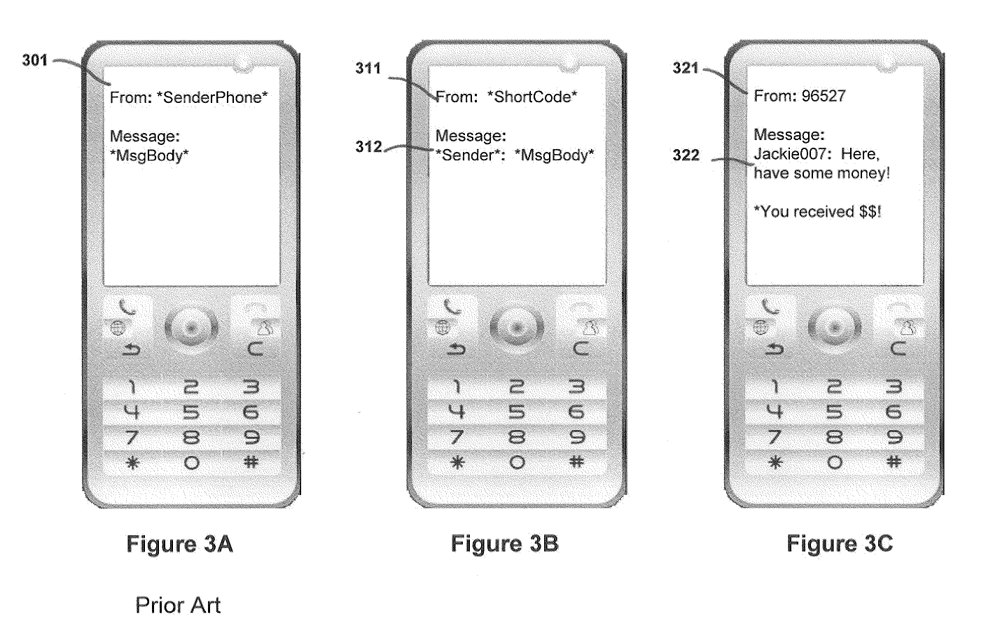

FIG. 2A illustrates a prior art interface for a sender to configure an out-going mobile message. The address-to field 201 is configured by the sender to identify the recipient of the intended message. The message is configured in message field 202. For SMS messaging, the recipient is identified by his mobile phone number. Thus, if the recipient wants to receive messages from the sender via SMS, typically, the recipient has to reveal his mobile phone number to sender, which is not in the recipient's best interest. FIG. 3A illustrates a prior art interface for a recipient to view a message received from a sender. The address-from field 301 displays to the recipient the identity of the sender, which is usually the mobile phone number of the sender. Thus, conversely, if the sender wants to send a message to a recipient, the sender generally has to reveal his mobile phone number to the recipient.

Herein disclosed is a system and method for anonymous mobile messaging (AMM) that does not require the user to download or install specialized software. An AMM system allows a user to send and receive mobile messages on his mobile phone without revealing the user's mobile phone number. It should be noted that “AMM Provider System” or “AMM system” or “AMM” are used interchangeably through the disclosure and should be understood to refer to the same system. FIG. 1B illustrates a high-level block diagram describing exemplary operations of mobile messaging with an AMM system, according to one embodiment. The sender configures the message at 111, which is then transmitted to the sender's mobile phone service provider (SSP) at 112. Instead of transmitting the message to the RSP, the message is transmitted to an AMM Provider System at 113. Having identified the intended recipient from the message, the AMM Provider System transmits the message, which may or may not be altered by the AMM, to the recipient's mobile service provider (RSP) at 114. The recipient receives and views the message at 115.

FIG. 2B illustrates an exemplary interface for a sender to configure an out-going mobile message, according to one embodiment. In contrast to the prior art approach shown in FIG. 2A, the address-to field 211 of the exemplary interface shown in FIG. 2B does not contain the mobile phone number of the recipient. Consistent with one embodiment, a number, or a shortcode (e.g. 96527), associated with AMM provider system 113 is used in the address-to field 211 instead. In one embodiment, all the senders in one country or geographical region may share one shortcode while the senders in a different country may share a different shortcode. In another embodiment, all the senders worldwide may share the same shortcode. Message field 212 is configured by the sender and may include information such as a keyword, recipient, suffix, or message body. An exemplary syntax—*Keyword* *Recipient*/*Suffix* *MsgBody*—for incorporating the information in message field 212 is shown in FIG. 2B. Incorporating the information in a particular syntax facilitates AMM Provider System in parsing and understanding the information. Other variations of syntaxes are contemplated but not shown. It is also contemplated that the information need not be arranged in a particular syntax for the AMM Provider System to parse and understand the information.

According to one embodiment, *Keyword* denotes a word or a combination of characters that triggers particular actions supported by the AMM Provider System at 113. Exemplary keywords may be “blog”, “block”, or “kiss”. “Blog” may result in a blog entry being entered into a blog. “Block” may result in blocking the user identified in *Recipient* from sending any messages to the sender. “Cash” may result in sending virtual money to the recipient. It is contemplated that multiple keywords may be used in combination to trigger multiple actions.

According to one embodiment, *Recipient* denotes a nickname that is used to identify the recipient of the message or the user a specific action is directed towards (e.g.—blocking a user identified by nickname). Users either choose or are assigned unique nicknames when they first register and setup a profile with the AMM Provider System or with an agent associated the AMM Provider System, such as a website. Users who are not registered are assigned unique guest nicknames, as will be discussed later. Personal information provided during user registration is deemed confidential and is substantially secured against parties not associated with the AMM Provider System. Thus, identifying users by their chosen or assigned nicknames presents almost no privacy risks to the users. In contrast, the prior art approach of identifying users by their mobile phone numbers compromises their privacy and even personal safety. As mentioned earlier, this is especially true because “reverse look up” services exist wherein a user's name and address may be found by looking up the user's mobile phone number.

According to one embodiment, *Suffix* denotes a word or a combination of characters that triggers actions or filters pre-configured by the sender. Exemplary suffixes may include “tel”, “info”, and others. “Tel” may be used to terminate a call between the sender and the recipient, managed as a call service for instance. “Info” may trigger incorporating the sender's profile in the message through a weblink in the message. Other configurable suffixes are contemplated. Configuration may be performed by users at the website by logging into the user's profile. Consistent with one embodiment, configuring the suffixes includes setting filters and/or choosing actions to associate with user-created or system-created suffixes. It is contemplated that multiple suffixes may be used in combination. *MsgBody* denotes the body of the message. According to one embodiment, the body of the message may contain text or weblinks or both.

FIG. 3B illustrates an exemplary interface for a recipient to view a message transmitted through the AMM Provider System 113, according to one embodiment. As shown, the address-from field 311 contains the shortcode instead of the sender's mobile phone number. The message field 312 may contain the sender's nickname *Sender* and the body of the message *MsgBody*. Message field 312 may also contain text or weblinks that are automatically incorporated in response to actions triggered by a keyword or a suffix.

FIG. 2C illustrates an exemplary out-going message configured by the sender, according to one embodiment. The address-to field 221 indicates that the message is transmitted to the AMM Provider System associated with shortcode “96527”. The message field 222 contains the character string “Cash Rob123/info Here, have some money!” The keyword “cash” indicates to the AMM Provider System that the sender is sending virtual money to the recipient. In response, the AMM Provider System may credit the recipient's account with a quantity of virtual money. “Rob123” indicates the recipient's unique nickname while “info” indicates the suffix, which, in this exemplary embodiment, triggers incorporating a weblink in the message that is sent out automatically to the sender afterwards. The character string “Here, have some money!” is part of the body of the message.

FIG. 3C illustrates an exemplary view of the message found in FIG. 2C, as received on the recipient's mobile phone, according to one embodiment. The received message includes the address-from field 321 and the message field 322. The address-from field 321 indicates that the message is transmitted from the AMM Provider System associated with shortcode “96527”. The message field 322 contains the character strings “Jackie007: Here, have some money!” and “*You received $$!”. “Jackie007” is the sender's nickname while “Here, have some money!” is part of the body of the message. “*You received $$!” may be automatically incorporated by the AMM system and indicates to the recipient that the sender used the keyword “cash” to send virtual money.

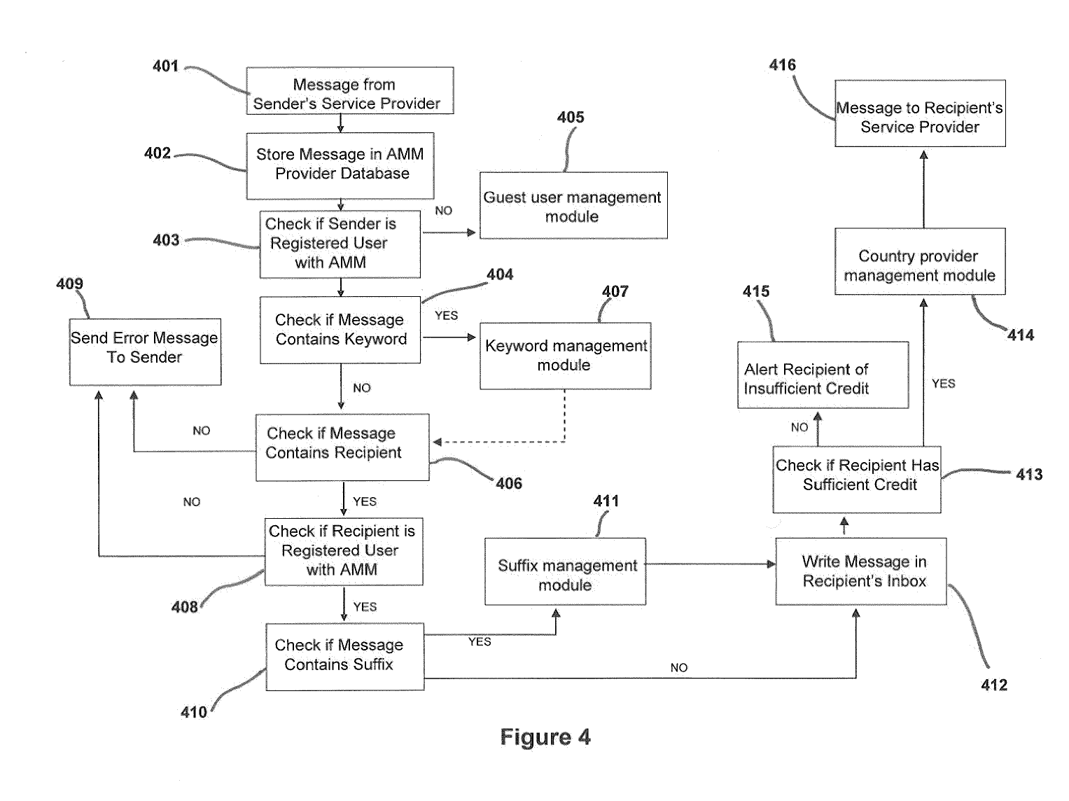

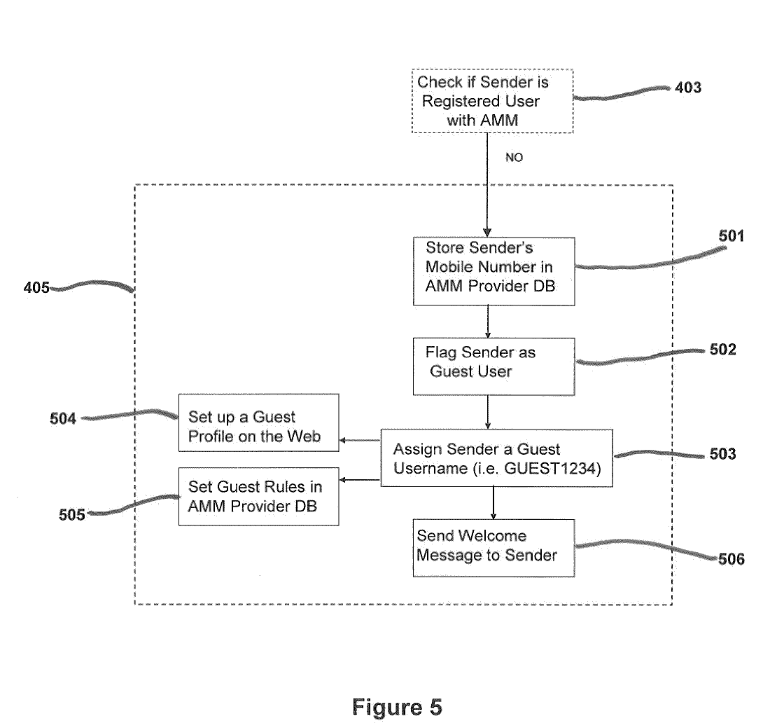

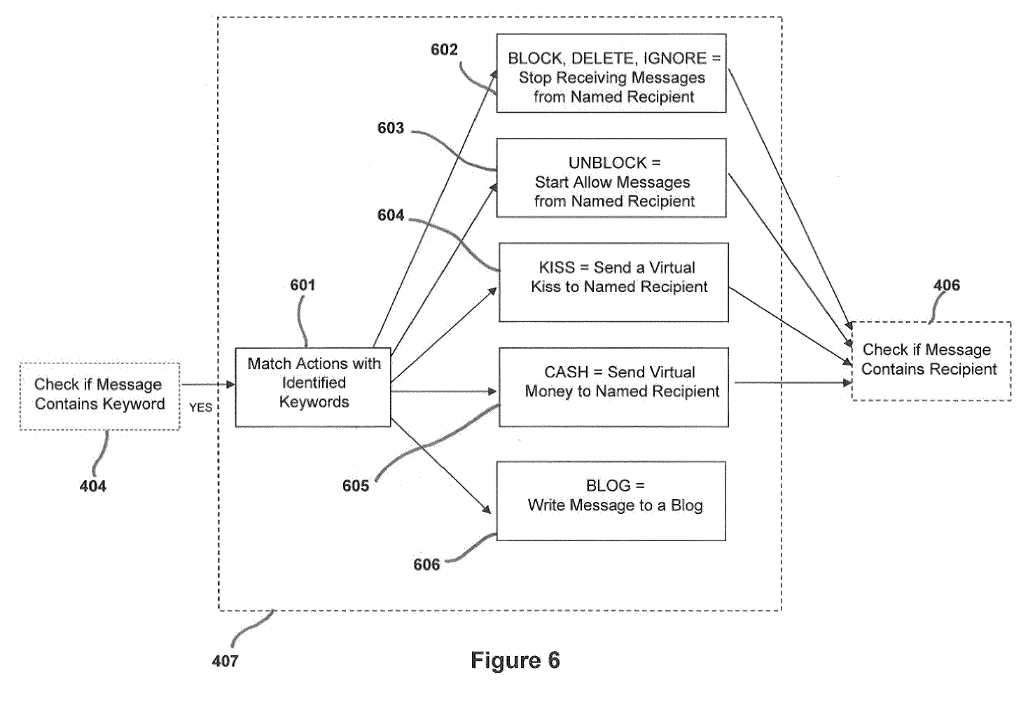

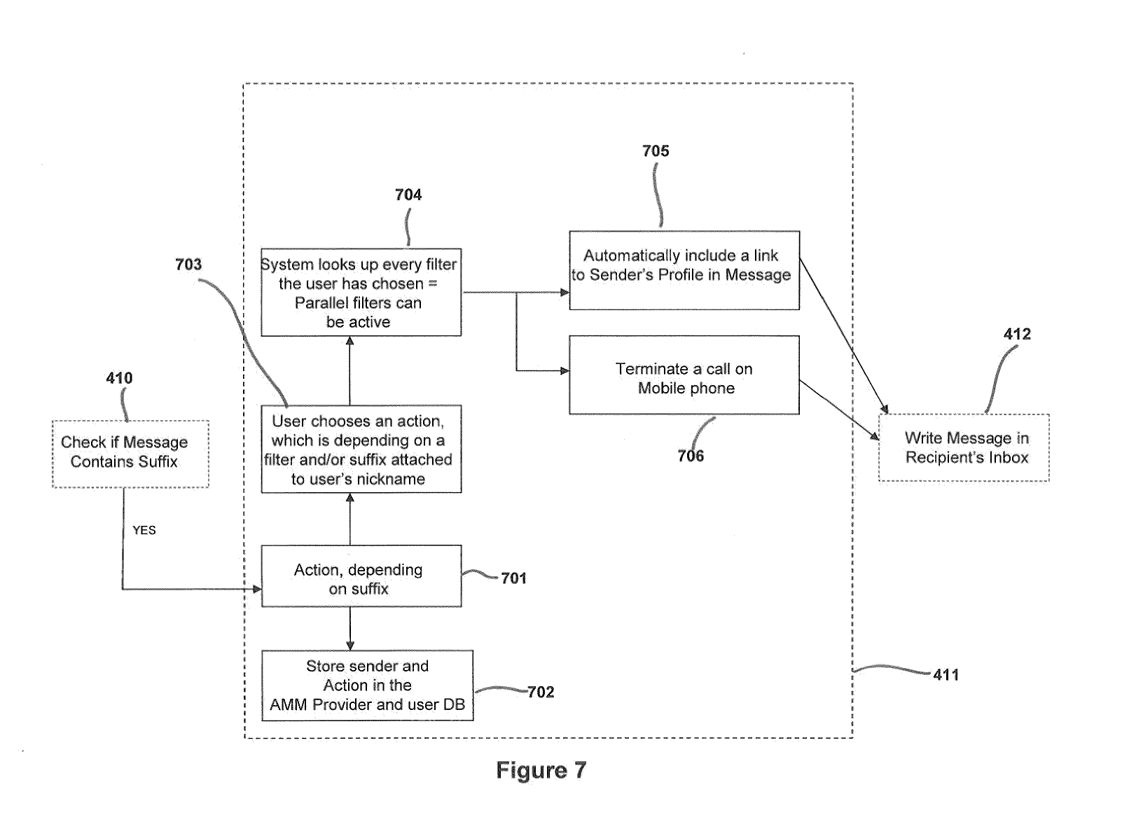

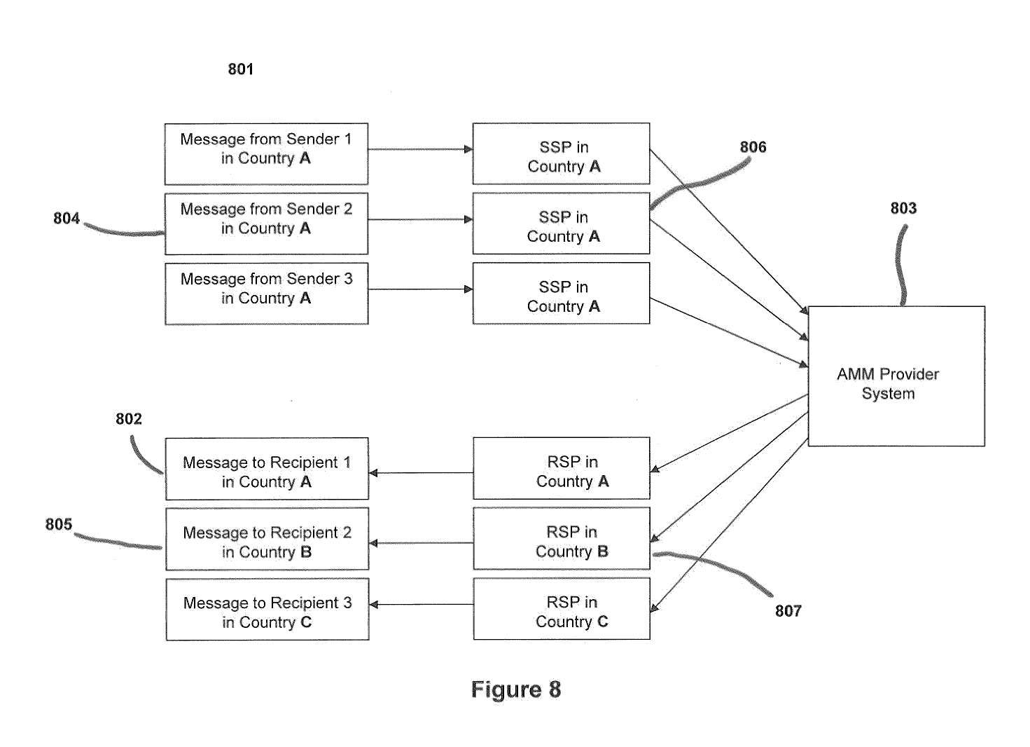

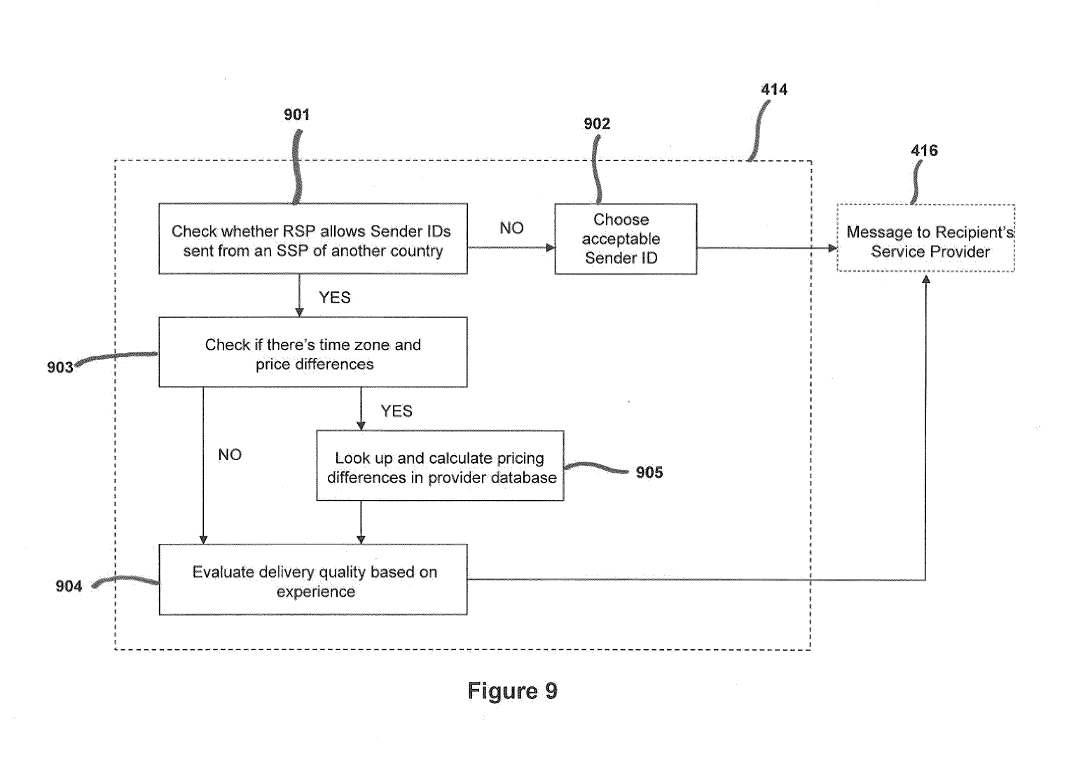

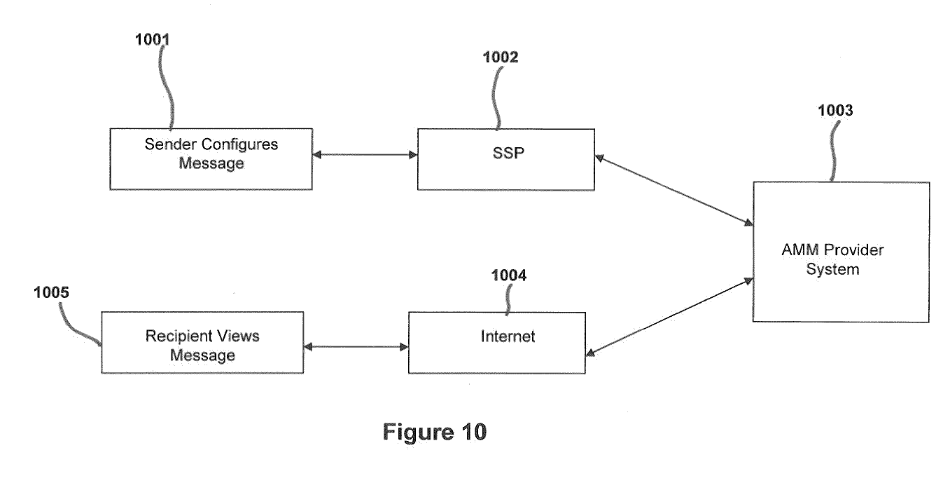

FIG. 4 illustrates a block diagram describing exemplary operations of an anonymous mobile messaging (AMM) Provider System 113, according to one embodiment. At 401, an interface is provided for receiving a message from the sender's mobile service provider (SSP). The message is stored into the AMM Provider Database at 402. The AMM checks to see if the sender is a registered user at 403. Consistent with one embodiment, the AMM determines whether the sender is a registered user based on the sender's mobile phone number. If the sender is a registered user, operation proceeds to 404. Otherwise, operation proceeds to guest user management module 405, which will be described in relation to FIG. 5. At 404, the AMM checks whether the message contains one or more keywords. If it does not contain a keyword, operation proceeds to 406. Otherwise, operation proceeds to keyword management module 407, which will be described in relation to FIG. 6. At 406, the AMM checks whether the message contains a recipient nickname. If it contains a nickname, operation proceeds to 408. Otherwise, operation proceeds to 409, wherein an error message is used to alert the sender, possibly by email or SMS. Other methods are also contemplated. At 408, the AMM's recipient management module checks whether the recipient is registered with the AMM. If the recipient is not registered with the AMM, operation proceeds to 409. If the recipient is registered with the AMM, the AMM will retrieve the recipient's mobile contact information from the database (e.g.—recipient's mobile number) and associate the contact information with the message. The contact information may also be used to determine the recipient's mobile service provider (RSP). Operation then proceeds to 410 and the AMM checks whether the message contains one or more suffixes. If it contains a suffix, operation proceeds to suffix management module 411, which will be described in relation to FIG. 7. Otherwise, operation proceeds to 412 and the AMM writes the message into the recipient's inbox. At 413, the AMM checks whether the recipient has a sufficient amount of credits to receive the message. If the recipient has enough credits, operation continues to country provider management module 414, which will be described in relation to FIGS. 8-9. Otherwise, operation proceeds to 415 and the recipient is alerted of the insufficiency. It is contemplated that the recipient may be alerted before the recipient runs out of credit (e.g.—when the recipient has only enough credit for 3 more messages). From 414, operation proceeds to 416, where an interface is provided for transmitting the message to the recipient's mobile service provider (RSP).

FIG. 5 illustrates a block diagram describing exemplary operations of the guest user management module 405, according to one embodiment. Operation proceeds to 501 after the AMM determines that the sender is not a registered user at 403 and the AMM stores the sender's mobile number in the AMM Provider Database. The sender is flagged as a guest user at 502 and assigned a unique guest username (e.g—GUEST1234) at 503. The AMM sets up a guest profile on a website that is associated with the unique guest username at 504. Guest rules are set in the AMM Provider Database at 505. At 506, the AMM sends the sender a welcome message that may include a weblink to the guest profile where the sender may register as a user.

FIG. 6 illustrates a block diagram describing exemplary operations of the keyword management module 407, according to one embodiment. Operation proceeds to 601 after the AMM determines that the message contains a keyword at 404. Keywords are generally pre-associated with one or more actions to be performed by the AMM system. Different actions may be triggered by different keywords and operation may proceed according to the keyword in the message. For instance, operation may proceed to 602, where keywords “BLOCK”, “DELETE”, or “IGNORE” may be associated with actions by the AMM system to prevent the sender from receiving messages from a certain user, as identified by his nickname in *Recipient*. The keyword “UNBLOCK” at 603 may be associated with actions that undo the actions associated with the keyword “BLOCK” and to once again allow the sender to receive messages from a blocked user. The “sender” is the user who originated the message containing the keyword. The keyword “KISS” may be used to send a virtual kiss to *Recipient* at 604 while the keyword “CASH” may be used to send virtual money at 605. Note, keywords, such as “BLOCK”, “UNBLOCK”, “KISS”, and “CASH”, trigger actions that are directed towards a user who may be specified in *Recipient* of message field 212. Thus, for blocks 603 to 605, operation proceeds to 406 to check if the message contains a *Recipient*. Keywords do not necessarily have to be directed at another user. For instance, the keyword “BLOG” at 606 may be associated with writing a message to a blog, and thus, operation may not necessarily proceed to 406. It is contemplated that multiple keywords may be used in combination to trigger a combination of actions by the AMM. It is noted that the keywords and associated actions discussed herein are for illustration purposes and are not meant to limit the scope of the disclosure. Keywords and associated actions different from the ones discussed above are contemplated.

FIG. 7 illustrates a block diagram describing exemplary operations of the suffix management module 411, according to one embodiment. Operation proceeds to 701 after the AMM has determined that the message contains a suffix at 410. Similar to a keyword, a suffix may be associated with one or more actions to be performed by the AMM system. Unlike a keyword, however, the actions associated with a suffix may be user configurable. A sender may configure his suffixes through a website associated with his profile at 703. Consistent with one embodiment, a sender may create unique suffixes and configure which and how many actions are triggered by each suffix. For instance, the sender may set one or more filters to associate certain actions with certain suffixes. The sender and the chosen actions are stored in the AMM Provider system and the user database at 702. Depending on the configuration of the filters and the suffix found in the sender's message, operation may proceed accordingly. At 704, the suffix found in the message is matched with the actions pre-selected by the sender. A unique suffix (e.g—“info”) may be associated with actions by the AMM to include the sender's profile through a weblink in the message and operation may proceed to 705. Operation may proceed to 706 if the suffix is associated with actions to terminate a call on the mobile phone. From 705 to 706, operation may proceed to 412, where the message may be written into the recipient's inbox. It is contemplated that multiple suffixes may be used in combination to trigger a combination of actions by the AMM. It is explicitly noted that the suffixes and associated actions discussed herein are for illustrative purposes and are not meant to limit the scope of the disclosure. Suffixes and associated actions different from the ones discussed above are contemplated.

FIG. 8 illustrates an exemplary block diagram of senders sending messages to recipients in the same or a different country, according to one embodiment. For instance, the message configured by sender 1 in country A at 801 may be sent to recipient 1 in country A at 802 while the message configured by sender 2, also in country A, at 804 may be sent to recipient 2 in country B at 805. Both messages are transmitted through the AMM Provider System at 803 before reaching the recipients in their respective countries. It is contemplated that the AMM Provider System 803 may be a single system or a network of systems.

When the AMM Provider System at 803 transmits the message received from the SSP at 806 to the RSP at 807, the AMM may need to choose a correct gateway because the SSP and the RSP are in different countries. The operations involved with choosing the correct gateway is performed by the AMM's country provider management module at 414, the exemplary operations of which are illustrated by the block diagram in FIG. 9. At 901, the AMM checks whether the RSP allows Sender IDs sent from an SSP of another country. If the RSP does not allow Sender IDs from another country, an acceptable Sender ID may be chosen at 902 for sending the message to the RSP at 416. Consistent with one embodiment, the Sender ID may be chosen such that the message appears to the RSP to have originated in the same country as the RSP. If the RSP does allow Sender Ds from another country, the AMM checks whether there exists time zone and price differences at 903. If there are no price differences, the quality or deliverability of the RSP is evaluated at 904 before sending the message to the RSP at 416. If there are price differences, the AMM looks up the pricing in the provider database and calculates the price differences at 905 before evaluating the quality or deliverability of the RSP at 904. Consistent with one embodiment, the quality or deliverability of a RSP may be evaluated based on past experiences of performance. Finally, the message may be sent to the RSP at 416.

While the system and method described herein relates to mobile-to-mobile messaging, such as SMS, it is contemplated that the system and method described herein can also be applied as described to other systems. For instance, the AMM may be used by an advertiser to send messages, via a mass messaging system, containing coupons or links to special offers to registered users on their mobile phone, while the identities of the users remain anonymous to the advertiser.

According to one embodiment, the AMM system may support SMS-to-Web or Web-to-SMS messaging such that an SMS may be sent to an email account and vice versa, as illustrated in FIG. 10. For instance, the sender may specify the recipient by his nickname at 1001 and the message is sent to the SSP at 1002. After the AMM system receives the message from the SSP at 1003, the message is sent through the internet at 1004 to an email address (e.g.—Hubert@hotmail.com) associated with the recipient's nickname at 1005. Thus, the sender does not need to know the recipient's email address to send him a message. If the receiver responds via email at 1005, the response is sent through the internet at 1004 to the AMM system at 1003, which then transmits the response to the SSP at 1002. Instances of the receiver's email address will be removed and replaced with the recipient's nickname (e.g.—Hubert) before the response is transmitted to the sender at 1001.

Embodiments and methods as described herein have significant advantages over prior art implementations. As will be apparent to one of ordinary skill in the art, other similar arrangements are possible within the general scope. The embodiments and methods described above are intended to be exemplary rather than limiting, and the bounds should be determined . from the claims.

We claim:

1. A system comprising:
a shortcode that identifies an anonymous mobile messaging system;
an I/O module of the anonymous mobile messaging system that receives a message from a sender's service provider and sends the message to a recipient's service provider; and
a recipient management module of the anonymous mobile messaging system that identifies an intended recipient of the message based on a recipient's nickname in the message.

2. The system of claim 1, further comprising a keyword management module that responds to a keyword found in the message.

3. The system of claim 1, further comprising a suffix management module that responds to a configurable suffix found in the message.

4. The system of claim 1, further comprising a guest management module that handles messages originating from a sender not registered with the anonymous mobile messaging system.

5. The system of claim 1, further comprising a country provider management module that determines whether the intended recipient's service provider allows a sender ID sent from a different country.

6. The system of claim 2, wherein the keyword management module includes a sub-module that identifies actions associated with the keyword found in the message and carries out the associated actions.

7. The system of claim 3, wherein the suffix management module includes a sub-module that identifies actions associated with the configurable suffix found in the message and carries out the associated actions.

8. The system of claim 4, wherein the guest management module includes a sub-module that assigns a unique guest nickname to the sender not registered with the anonymous mobile messaging system.

9. The system of claim 5, wherein the country provider management module includes a sub-module that selects a sender ID for sending the message such that the message appears to the recipient's service provider to have originated in the same country as the recipient's service provider.

10. A method comprising:
receiving a message from a sender's service provider;
identifying the intended recipient of the message based upon a recipient's nickname in the message; and
sending the message to the intended recipient's service provider.

11. The method of claim 10, further comprising responding to a keyword found in the message.

12. The method of claim 10, further comprising responding to a configurable suffix found in the message.

13. The method of claim 10, further comprising handling messages originating from a sender not registered with an anonymous mobile messaging service.

14. The method of claim 10, further comprising determining whether the intended recipient's service provider allows a sender ID sent from a different country.

15. The method of claim 11, wherein responding to a keyword found in the message includes identifying actions associated with the keyword and carrying out the associated actions.

16. The method of claim 12, wherein responding to a configurable suffix found in the message includes identifying actions associated with the configurable suffix and carrying out the associated actions.

17. The method of claim 13, wherein handling messages originating from a sender not registered with an anonymous mobile messaging service includes assigning a unique guest nickname to the sender.

18. The method of claim 14, wherein determining whether the intended recipient's service provider allows a sender ID sent from a different country includes selecting a sender ID for sending the message such that the message appears to the recipient's service provider to have originated in the same country as the recipient's service provider.

19. The method of claim 10, wherein receiving a message from a sender's service provider includes receiving the message from a sender's email service provider and wherein sending the message to the intended recipient's service provider includes sending the message to the intended recipient's SMS service provider.

20. The method of claim 10, wherein receiving a message from a sender's service provider includes receiving the message from a sender's SMS service provider and wherein sending the message to the intended recipient's service provider includes sending the message to the intended recipient's email service provider.
